(19) United States
(12) Patent Application Publication
(10) Pub. No.: US 2018/0217576 A1
(43) Pub. Date: Aug. 2, 2018

(54) Palletizer Human-Machine Interface (HMI) for Custom Pattern Preview

(71) Applicant: Intelligrated Headquarters, LLC, Mason, OH (US)

(72) Inventors: Steven W. GRIGGS, St. Charles, MO (US); Madhav PATIL, St. Louis, MO (US); James Nicholas NEWTON, St. Charles, MO (US)

(21) Appl. No.: 15/885,678

(22) Filed: Jan. 31, 2018

Related U.S. Application Data
(60) Provisional application No. 62/452,414, filed on Jan. 31, 2017.

(51) Int. Cl. G05B 19/409; G05B 19/31; G06F 3/0482

(52) U.S. Cl. CPC G05B 19/409; G05B 19/31; G05B 2219/40099; G05B 2219/32423; G05B 2219/40518; G06F 3/0482

(57) ABSTRACT

Various embodiments are related to processor subsystems of material handling systems performing methods of creating one or more case placement patterns for placement of cases on a pallet by a palletizer. A human-machine interface (HMI) is executed by the processor subsystem that provides a control affordance to a user, selection, or to provide numerical inputs, for creating or selecting pre-created patterns. The HMI is adapted to provide preview of patterns in real-time, while the patterns are created. In this regard, the preview of patterns corresponds to currently positioned representations of cases on a pallet. The HMI is also adapted to render dynamic changes on the previewed pattern as the cases are positioned on the pallet, in real world, by the palletizer.

### CROSS-REFERENCE TO RELATED APPLICATIONS

This application claims the benefit of priority under 35 U.S.C. § 119(e) to U.S. Provisional Application Ser. No. 62/452,414 entitled “Palletizer Human-Machine Interface (HMI) for Custom Pattern Preview,” filed, Jan. 31, 2017, the contents of which are incorporated herein by reference in their entirety.

### BACKGROUND

The present disclosure relates in general to material handling systems that include palletizing of cases onto a pallet unitizer, and more particularly to systems that allow customizing and previewing of a palletizing pattern via a human-machine interface (HMI) for a palletizer.

### BRIEF SUMMARY

In accordance with the teachings of the present disclosure, a method is provided for creating and visualizing patterns for placement of the cases in layers on a pallet. In one or more embodiments, the method includes receiving on a pattern forming human-machine interface (HMI) inputs corresponding to the patterns, from an operator. In this regard, the inputs received on the HMI corresponds to one of (a) a creation of a new case placement pattern, or (b) selection of a pre-loaded pattern, from amongst a set of pre-loaded patterns. The new case placement pattern and the set of the pre-defined case placement patterns are representative of patterns for placement of cases on a conveyor that are to be conveyed and machine for placement by a palletizing unit. The method includes displaying, on the HMI, in real time, a preview of one of the created new case placement pattern or the selected pre-loaded pattern. In this regard, the preview is based on inputs received on the HMI or PC. The method further includes, providing dynamic visual indications in real time on the displayed preview of the pattern. The visual indications, in this regard, correspond to placement of the cases on one or more positions on the pallet, by the palletizing unit, based on the displayed pattern preview, while the palletizing unit is in execution, i.e. while the palletizing unit is placing articles on the pallet.

In accordance with embodiments of the present disclosure, a palletizing system includes a palletizing unit comprising at least one pallet, sheet dispenser, hoist table, a conveyor unit, a user interface device, and a processor subsystem coupled to the user interface device to execute a pattern forming human-machine interface (HMI). In this regard, the processor subsystem presents on the HMI a pattern depiction of any currently positioned representation of cases on a pallet. On the HMI, the processor subsystem, via the user interface device, receive inputs corresponding to one of creation of a new case placement pattern or selection of a pre-loaded pattern, from amongst a set of pre-loaded patterns. In this regard, either of the new case placement pattern or the selected pre-loaded pattern is representative of patterns corresponding to placement of cases, by the palletizing unit, on the pallet. The processor subsystem via the HMI displays in real time i.e. while the palletizing unit is in execution, a preview of either of the created new case placement pattern or the selected pre-loaded pattern, on the HMI. In this regard, the preview is based on the inputs received on the HMI. Further, the processor subsystem, via the HMI, also provides dynamic visual indications, in real time, on the displayed preview of the pattern. The visual indications herein, are corresponding to placement of the cases on one or more positions on the pallet based on the displayed pattern preview, while the palletizing unit is placing articles on the pallet.

In accordance with another aspect, inputs corresponding to the creation of the new case placement pattern comprise at least one of: a pattern type, a pattern identifier, case dimensions, an offset distance, or a cases per layer number.

In accordance with another aspect, displaying on the user interface device, in real-time while the palletizing unit is in execution, the preview is based on accessing plurality of pattern forming factors comprising at least one of: a pattern type, a pattern identifier, case dimensions, an offset distance, or a cases per layer number.

In accordance with another aspect, the pattern forming HMI is further configured to: receive, via the user interface device, inputs correspond to one or more changes in at least one of the pattern forming factors comprising: a pattern type, a pattern identifier, case dimensions, an offset distance, or a cases per layer number; and adjust the preview, in real-time while the palletizing unit is in execution, based on the received inputs.

In accordance with another aspect, the pattern forming HMI is further configured to: provide, on the user interface device, a selectable icon for selecting a HMI orientation with respect to the palletizing unit, wherein the HMI orientation is selected from: an up-left side relative to the palletizing unit, an up-right side relative to the palletizing unit, a down-right side relative to the palletizing unit, a down-left side relative to the palletizing unit, a left-up side relative to the palletizing unit, a left-down side relative to the palletizing unit, a right-up side relative to the palletizing unit, or a right-down side relative to the palletizing unit.

In accordance with another aspect, the preview comprises a plurality of case position placeholders indicative of positions where cases are to be placed by the palletizing unit.

In accordance with another aspect, wherein the dynamic visual indications comprise dynamic color adjustments on one or more case position placeholders of the plurality of case position placeholders, wherein each of the dynamic color adjustments indicates a corresponding case being placed by the palletizing unit in real-time.

In accordance with another aspect, the pattern forming HMI is further configured to: display, on the user interface device, an infeed flow visualization indicative of a movement direction of infeed cases on an infeed conveyor, wherein the infeed cases are placed by the palletizing unit on the pallet.

In accordance with another aspect, the pattern forming HMI is further configured to: receive inputs to search the set of pre-defined case placement patterns stored in a non-transitory memory connected to the processor subsystem.

In accordance with another aspect, displaying on the user interface device, in real-time while the palletizing unit is in execution, the preview further comprises: generating, based on the inputs received via the user interface device, pattern case view data, wherein the pattern case view data is indicative of operation sequences to be performed by the palletizing unit; and determining, for each case on the pallet, a case position based on the pattern case view data.

The above presents a general summary of several aspects of the disclosure in order to provide a basic understanding of at least some aspects of the disclosure. The above summary contains simplifications, generalizations and omissions of details, and is not intended as a comprehensive description of the claimed subject matter. Rather, it is intended to provide a brief overview of some of the functionality associated therewith. The summary is not intended to delineate the scope of the claims, and the summary merely presents some concepts of the disclosure in a general form as a prelude to the more detailed description that follows. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a schematic representation a material handling system having a controller with a processor subsystem that executes a HMI for creating and previewing patterns according to one or more embodiments;

FIG. 2 illustrates a flow diagram of a method of creating and visualizing patterns for placement of the cases in layers on a pallet, according to one or more embodiments;

FIG. 3 illustrates a schematic representation of a user interface presenting HMI location for upstream or downstream conveyors according to one or more embodiments;

FIG. 4 illustrates a schematic representation of a user interface presenting HMI location for left or right conveyors, according to one or more embodiments;

FIG. 5 illustrates a data structure for hexadecimal type conversion for creating patterns, according to one or more embodiments;

FIG. 6 illustrates an human-machine interface (HMI) for creating and visualizing pattern previews according to one or more embodiments;

FIG. 7 illustrates a pattern preview displayed on a HMI, according to one or more embodiments;

FIG. 8 illustrates a pattern preview displayed on a HMI after changing dimensions of cases, according to one or more embodiments; and

FIG. 9 illustrates a pattern preview displayed on a HMI and dynamic changes on the pattern preview, while a palletizer machine is in run mode, according to one or more embodiments;

FIG. 10 illustrates a schematic diagram according to one or more embodiments;

FIG. 11 illustrates a data flow related to determining the X position of a case according to one or more embodiments;

FIG. 12 illustrates a schematic diagram related to determining the Y position of a case according to one or more embodiments;

FIG. 13 illustrates a data flow related to determining the Y position of a case according to one or more embodiments; and

FIG. 14 illustrates a flow chart according to one or more embodiments.

### DETAILED DESCRIPTION

Various embodiments of the present invention now will be described more fully hereinafter with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### Overview

In industrial environments, such as warehouses, factories, or distribution centers, manually placing cases on pallets is time consuming, complex, and expensive. Further, there is always a risk of damaging, wear and tear, associated with dropping of cases during manual placement. Thus, material handling systems are largely utilized for automating various tasks and handling various items. In this regard, using case stoppers and row pushers, material handling systems are able to sort and organize cases (e.g. cartons, cases, items, boxes etc.) stored in such industrial environments at high speeds. This is achieved using both software and hardware support of material handling technology, for instance, by using software or hardwired programmable logic controllers (PLCs) or computing systems that handle and drive hardware palletizers, including palletizers with motion flow dividers, that automate guiding items on pallets. Thus, palletizer systems have been developed to facilitate stacking of various cases on pallets from multiple locations along a conveyor system, i.e. from an induction point or from an item scanning position etc. Some generally-known palletizer systems operate based on commands provided by controllers, such as PLCs for guiding cases and positioning the cases on various locations on a pallet.

Some palletizing systems are pre-loaded with a number of pallet pattern “recipes” that can be selected for a given size of cases, such as cartons or boxes, that will be stacked on a particular pallet. In this regard, the patterns define a manner in which multiple cases are to be arrayed up on a pallet. Although many such patterns can be provisioned on the system by an original equipment manufacturer (OEM), customization is often required depending on different scenarios for placement of cases on pallets. For instance, in one scenario, on a particular stock keeping unit (SKU), the container such as a carton, shrink wrap, bag, etc., can introduce an unusual shape. In another scenario, certain manufacturers, distributor, or retailers can have particular logos and markings that are to be positioned on an outside of the stack to facilitate shipping or for direct placement in a retail aisle. In another scenario, a pallet load can include mixed cases for store replenishment when the particularly selected SKUs are insufficient for a full pallet load per SKU. In another scenario, particular SKUs have a given structural integrity, size or frictional characteristic that require positioning of cases within a particular lateral or vertical position. Depending on such scenarios, there is often a requirement of visualization of placement of cases and identification of a relevant pattern which optimally can accommodate all cases.

Material handling systems utilize various components for automating different tasks which are to be performed in a material handling environment, such as a warehouse, a logistic center, a distribution center, a stock keeping unit (SKU), an inventory or a manufacturing unit. Palletizing units, such as ones including case stoppers and row pushers, are used for sorting and guiding cases onto desired places. For instance, in some environments, palletizers are utilized to divide multiple cases from a conveyor system, such as a conveyor belt and place the cases on placement zones like on pallets, cubbies, put walls or shelves. In palletizer systems, considerable thought is invested for placement of such cases on the pallet so that maximum number of cases may effectively and safely occupy volume for placement on the pallet without wasting any space. In many of such environments, placement of such cases may be performed based on patterns that may be pre-loaded in a database and may be accessed by a programmable logic controller to perform guiding and placing of cases based on the patterns. As may be understood, these patterns represent a manner in which cases are to be placed on layers on the pallet. For creating such patterns, human-machine interfaces (HMI) is provided along with processing devices, such as programmable logic controllers (PLCs), for handling operations of palletizer and defining patterns or rules. Moreover, usually, patterns are often considered for optimizing space allocation and allotment of cases on a pallet and for reducing overall conveyor turnaround time. However, in conventional approaches, providing ease of access to an operator for utilizing such HMIs and configuring PLCs with such patterns, have associated challenges. For example, existing HMIs lack the capability for providing user friendly input interface to an operator so that an operator can easily define patterns, or define configuration parameters for palletizers, or provide cases guiding and placement locations in a lesser turnaround time.

Moreover, for formation of patterns and configuring the PLC for the patterns, in conventional systems, an operator needs to manually edit and create hexadecimal scripts or code files. In these systems, machine files including hexadecimal scripts defining patterns are pre-loaded into a memory and are processed by the PLC, which then generates commands for a palletizer machine to operate accordingly for placement of cases as per the loaded patterns. Manual creation and editing in hexadecimal code files, by operators, are complex and error prone processes for various reasons. For instance, in some situations, for each item dimension or case type, the operator has to update or write the hexadecimal code file every time a new case type is to be considered. This requires the operator to be thoroughly trained in editing and handling such hexadecimal code files. Further, for emulating, while editing code files for defining patterns every time for a new case dimensions, PLC and machine components have to be re-initialized again or connected online and disconnected, which consumes a lot of time and ultimately, reduces overall conveyor system throughput.

The present subject matter relates to a material handling system, particularly, a palletizing system, for handling and positioning various cases in environments such as inventory, warehouse, or manufacturing units. According to various exemplary embodiments described herein, the palletizing system includes: a palletizing unit, a case conveyor or infeed conveyor, a user interface device, and a controller. The controller comprises a processor subsystem, for performing various tasks related to placement of cases on pallets. In this regard, the processor subsystem, upon execution, provides a human-machine interface (HMI). The HMI includes an input control unit having control affordance to receive various inputs from an operator. In an aspect, the inputs may pertain to any of, but not limiting to, (a) creation of new case placement patterns, (b) selection of pre-loaded patterns, and (c) placement and positioning of cases on various locations based on created or selected patterns. In this regard, the inputs provided on the HMI are accessed by the controller, like a PLC, and processed for providing instructions to the palletizing unit such as, a palletizer having case stoppers and row pushers, for forming cases in rows, at desired locations on pallets.

According to various embodiments described herein, the HMI is adapted to receive inputs such as corresponding to one of: creation of a new case placement pattern and selection of a pre-loaded pattern, from amongst multiple pre-loaded patterns. In this regard, the patterns, i.e. either of the new case placement pattern or the selected pre-loaded pattern, may represent a manner or an order of placement of cases on a pallet, that are to be guided by the palletizing unit. According to various embodiments, the HMI is adapted to display, in real-time, i.e., while the palletizing unit is in execution or a run-mode for guiding cases onto pallets, preview of any of the created new case placement or the selected pre-loaded pattern. Further, the HMI is also adapted to provide dynamic visual indications on the displayed preview of the pattern such that, the dynamic visual indications emulate placement of the cases on one or more positions on the displayed patterns.

In accordance with the embodiments described herein, the HMI is adapted to receive inputs indicative of various parameters for defining the patterns, for instance, dimensions of cases (such as, boxes, cartons, packets etc.) or number of cases to be placed per layer on the conveyor case, etc. which are to be processed by the PLC. Alternatively, according to another embodiment of the present subject matter, the HMI is adapted to receive inputs pertaining to selection of pre-loaded patterns, i.e. patterns pre-defined by an operator and stored in a memory accessible to the PLC. In this regard, the PLC processes the inputs received on the HMI interface and sends commands for programming the palletizing unit system for positioning cases on pallets based on the processed inputs and the pre-loaded patterns.

Thus, by the way of implementation in accordance with various embodiments of the present subject matter, real time preview of either (a) newly created patterns or (b) patterns selected from amongst pre-loaded patterns, is provided in a real-time, emulated manner as the cases are placed based on such patterns, by a palletizer, on the pallets. As such, the real-time preview and emulation of case placement on pattern preview is provided, while the palletizing unit is in execution, i.e. while a palletizer is actually placing cases on pallets in real-world, (a) repetitive interpretation of processing of hexadecimal code files for creating patterns by operators, (b) wastage of time for re-configuring, connecting, and disconnecting the PLC as the operator defines the patterns, and (c) overall high turnaround time for a palletizer, may be avoided. Further, no additional time and effort may be required in training an operator to understand complex hexadecimal source code files and creating the patterns, thereby saving cost and time. Additionally, by visualizing the placement of cases on positions marked on patterns, the operator may perform troubleshooting and fault repairing operations on a palletizer system during its execution itself.

In one aspect, various embodiments of the present invention can be implemented on row-forming palletizers. In another aspect, various embodiments of the present invention can be implemented on in-line palletizers. In another aspect, various embodiments of the present invention can be implemented on robotic units, such as a robotic palletizer machine or a robotic arm.

### Definitions

As used herein, the terms “data,” “content,” “digital content,” “digital content object,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “case” refers to a carton, box, container, bin, or any three-dimension structure that is capable of storing articles, goods, items, etc. to be sorted or transported. In some embodiments, each case has the same or similar height, width, and/or length.

The term “pallet” refers to a structure that supports cases in a stable fashion while being handled or transported by transportation means, such as forklifts, canes, conveyors, etc. in some embodiments, a pallet supports multiple “layers” of cases, and each case, layer has a “footprint” (perimeter) that approximates the perimeter of the pallet.

The term “case placement pattern” refers to an arrangement or an order of cases on a pallet. A case placement pattern defines the manner in which multiple cases are to be arrayed on a pallet. In some embodiments, a pallet has multiple layers, and case placement pattern among the layers may be the same, substantially similar, or different.

The term “palletizing unit” (or “palletizer”) refers to an automatic system that directs, sorts, and/or stacks cases to form a case placement pattern on a pallet. In some embodiments, a palletizing unit includes motion flow dividers and pushers, which guide the cases into the appropriate locations to form the desired case placement pattern.

The term “human machine interface” or “human-machine interface” (“HMI”) refers to a user interface that connects an operator to a controller of a system. In this regard, the controller refers to integrated hardware and software designed to monitor and control the operation of machinery and associated devices in industrial environments, and an HMI includes electronic components for signaling and controlling the machinery and associated devices. An HMI may receive input data via one or more input devices, including, for example, keyboards, toggles, switches, touch screens, joysticks, and mice. An HMI may also translate data from the controller into human-readable visual representations via, for example, a computer display.

### Example System Architecture for Implementing Embodiments of the Present Invention

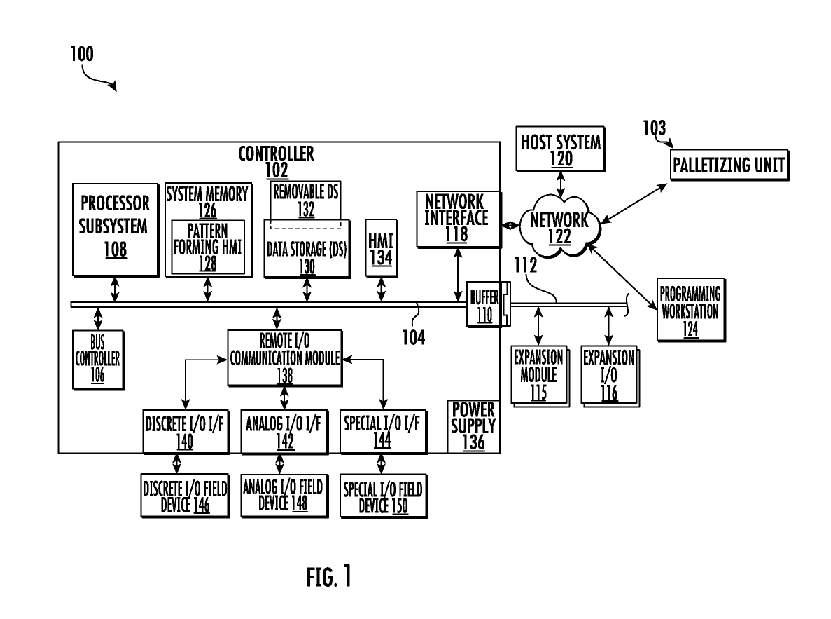

FIG. 1 illustrates a material handling system 100 that provides an exemplary environment within which one or more of the described features of the various embodiments of the disclosure can be implemented. A controller 102 accesses customized patterns created based on operator's inputs and converts them into commands for a palletizing unit 103. In some embodiments, the palletizing unit 103 includes case stoppers and row pushers for handling various cases on a conveyor. For example, the palletizing unit 103 comprises one or more case stoppers, positioned on the infeed conveyor, to separate cases that are fed to the palletizing unit 103. The palletizing unit 103 may also comprise one or more case turners to rotate the cases on the infeed conveyor, and one or more row pushers to push one or more cases on the infeed conveyor. In various embodiments, the one or more row pushers may form a pusher bar track. As cases are pushed by the row pusher, one or more “rows” are formed. In accordance with various embodiments of the present invention, data related to whether case stoppers, row pushers and case turners are activated are utilized in various algorithms that determine case physical positions, details of which are described hereinafter regarding FIGS. 10-12.

In some embodiments, the controller 102 can be implemented as a unitary device or distributed processing system. The controller 102 includes functional components that communicate across a system interconnect of, such as, one or more conductors or fiber optic fabric that for clarity is depicted as a system bus 104. The system bus 104 may include a data bus, address bus, and control bus for communicating data, addresses and control information between any of these coupled units. A bus controller 106 can provide infrastructure management of the system bus 104. Processor subsystem 108 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes including control of automation equipment of a material handling system. The controller 102 may be scalable, such as having a buffer 110 on the system bus 104 that communicatively couples with an expansion bus 112 for communicating and interfacing to expansion modules 115 and expansion input/output (I/O) 116.

In accordance with various aspects of the disclosure, an element, or any portion of an element, or any combination of elements, may be implemented with processor subsystem 108 that includes one or more physical devices comprising processors. Non-limiting examples of processors include microprocessors, microcontrollers, digital signal processors (DSPs), field programmable gate arrays (FPGAs), programmable logic devices (PLDs), programmable logic controllers (PLCs), state machines, gated logic, discrete hardware circuits, and other suitable hardware configured to perform the various functionality described throughout this disclosure. One or more processors in the processing system may execute instructions. A processing system that executes instructions to affect a result is a processing system which is configured to perform tasks causing the result, such as by providing instructions to one or more components of the processing system which would cause those components to perform acts which, either on their own or in combination with other acts performed by other components of the processing system would cause the result.

Controller 102 may include a network interface device (NID) 118 that enables controller 102 to communicate or interface with other devices, services, and components that are located external to controller 102, such as a host system 120. Host system 120 can provide scheduling information to the controller 102 such as identification of items being directed to a controlled component and their assigned destination. Host system 120 can provide programming for the controller 102 and obtain diagnostic and status monitoring data. These networked devices, services, and components can interface with controller 102 via an external network, such as example network 122, using one or more communication protocols. Network 122 can be a local area network, wide area network, personal area network, and the like, and the connection to and/or between network and controller 102 can be wired or wireless or a combination thereof. For purposes of discussion, network 122 is indicated as a single collective component for simplicity. However, it is appreciated that network 122 can comprise one or more direct connections to other devices as well as a more complex set of interconnections as can exist within a wide area network, such as the Internet or on a private intranet. For example, a programming workstation 124 can remotely modify programming or parameter settings of controller 102 over the network 122. Various links in the network 122 can be wired or wireless.

System memory 126 can be used by processor subsystem 108 for holding functional components such as data and software such as a pattern forming HMI 128 that is retrieved from data storage 130. Data and software can be provided to the controller 102 or exported from the controller 102 via removable data storage (RDS) 132. Software may be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, function block diagram (FBD), ladder diagram (LD), structured text (ST), instruction list (IL), and sequential function chart (SFC) or otherwise. The software may reside on a computer-readable medium.

In some embodiments, system memory 126 is random access memory, which may or may not be volatile, and data storage 130 is generally nonvolatile. System memory 126 and data storage 130 contain one or more types of computer-readable medium, which can be a non-transitory or transitory. Computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system. The computer-readable medium is non-transitory. In some embodiments, one or more external systems (such as a remote cloud computing and/or data storage system) may also be leveraged to provide at least some of the functionality discussed herein.

Certain manual interactions and indications can also be provided via a human-machine interface (HMI) 134 that is integral or connected to the controller 102. HMI can be formed of one or more devices that provide input and output functions such as via a touch screen graphical display, keypad, microphone, speaker, haptic device, camera, gauges, light indicators, dials, switches, etc. A power supply 136 provides regulated voltages at required levels for the various components of the controller 102 and can draw upon facility power. According to various embodiments disclosed herein, the processor subsystem 108 of the controller 102 may execute the HMI 134 that provides various pattern forming HMIs 128 for various purposes, including but not limited to, receiving inputs from an operator or displaying previews of patterns on a display.

A remote I/O communication module 138 can provide communication protocol for handling of various inputs and outputs between the system bus 104 and controller interfaces such as a discrete I/O interface/s 140, analog I/O interface/s 142, and special I/O interface/s 144. Each interface 140, 142, 144 can provide as necessary analog-to-digital or digital-to-analog conversion, signal processing, buffering, encoding, decoding, etc., in order to communicate with the discrete I/O field device 146, analog I/O field device 148, or special I/O field devices 150, respectively, the details of which are describe hereinafter.

### Example Methods for Implementing Embodiments of the Present Invention

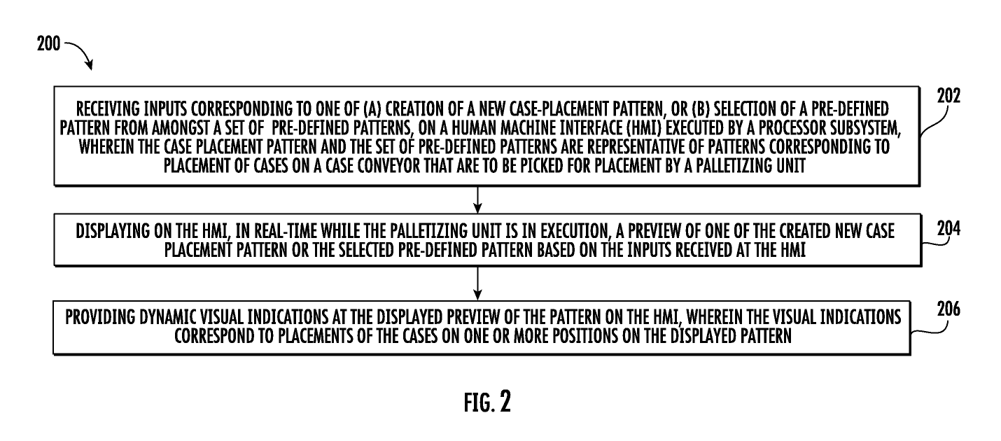

FIG. 2 illustrates a method 200 of creating and visualizing preview of patterns for placement of cases on a pallet. In one or more embodiments, method 200 begins with receiving, by the HMI 134 on a user interface, inputs from an operator (block 202). In some embodiments, on the HMI 134, the inputs are received corresponding to one of: a creation of a new case placement pattern, or a selection of a pre-loaded pattern from amongst multiple pre-loaded patterns, i.e. patterns pre-defined and stored in a storage device. Illustratively, the new case placement pattern may represent a new pattern which an operator desires to create. In this regard, the new pattern may be created depending on various parameters such as dimensions of cases, case type, number of cases to be placed in a pattern, etc. In this regard, for creating the new case placement pattern, attributes to various parameters may be provided from the HMI and be loaded on the system memory 126 to maintain a repository of patterns (such as pattern forming HMIs 128) that is accessible to the processor subsystem 108. Illustratively, to create the new case placement pattern, the HMI 134 is adapted to receive inputs corresponding to plurality of pattern forming factors comprising at least one of: a pattern type, a pattern identifier, case dimensions, an offset distance, and/or number of cases to be placed per layer. Alternatively, in some embodiments, the inputs may correspond to selection of a pre-loaded pattern, from amongst multiple pre-loaded patterns. Illustratively, the multiple pre-loaded patterns may be stored in the system memory 126 into pattern forming HMIs 128. In this regard, the processor subsystem 108 may be pre-configured to access the pre-loaded pattern forming HMIs 128 and execute commands to the palletizing unit 103. In one embodiment, the selecting of pre-defined pattern may also comprise of, searching via the user interface, a pre-loaded pattern based on one or more pattern forming inputs provided via the HMI 134.

In response to receiving the inputs, method 200 includes displaying, in real-time, i.e. when the palletizing unit 103 is in execution and initialized for placing cases on pallet, a preview of either of the created new case placement pattern or the selected pre-loaded pattern (block 204). In this regard, the preview may be displayed on a display screen, via the user interface of the HMI 134. The pattern preview represents a manner or an order of placement of cases in which various cases may be conveyed and placed by the palletizing unit 103 on a pallet. The details of which are described hereinafter.

Illustratively, in some embodiments, upon receiving of the inputs, the method may further include converting the received inputs into a case placement sequence. In this regard, the case placement sequence may be indicative of sequence of operations to be perform by the palletizing unit for placement of the cases. Upon displaying the preview of the pattern, method 200 further includes providing dynamic visual indications at the displayed preview of the patterns (block 206). In this regard, the visual indications may be provided in a dynamic fashion, for instance, in an emulated manner of changing colors of case placement positions on the pattern preview, as cases are placed on the pallet by the palletizing unit 103 in real time based on the displayed preview on the HMI 134. The details of which are described hereinafter.

In the above described flow chart of FIG. 2, one or more of the methods may be embodied in an automated controller that performs a series of functional processes. In some embodiments, certain steps of the methods are combined, performed simultaneously or in a different order, or omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

### Example Schematic Diagrams in Accordance with Embodiments of the Present Invention

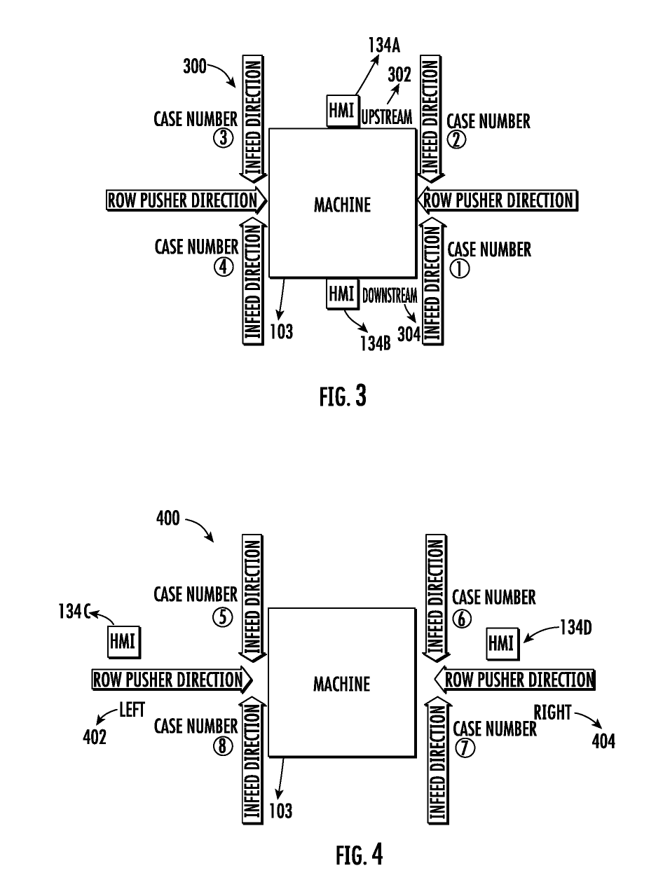

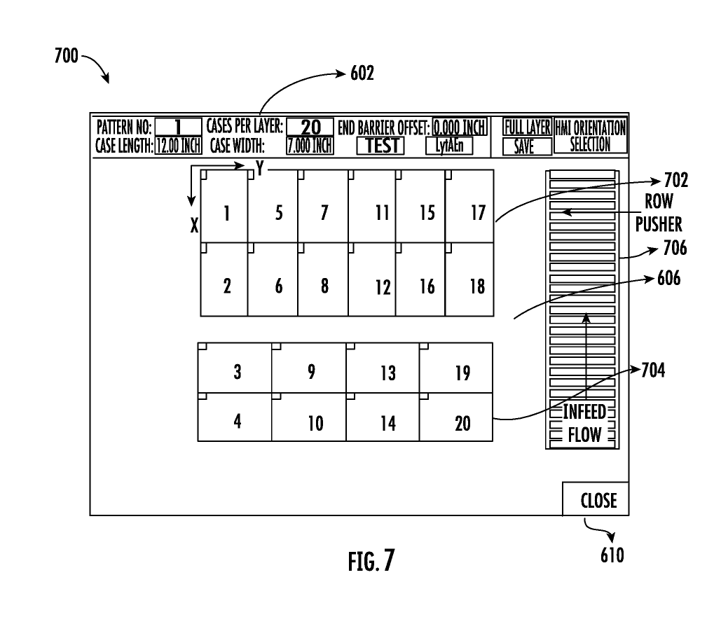

FIGS. 3-4 illustrate schematic representations of installation locations for a human-machine interface (HMI), such as the HMI 134 described with regard to FIG. 1, on a palletizing machine. The installation location of the HMI determines the orientation of the HMI, details of which are described with regard to FIGS. 6-9.

For example, as illustrated in FIG. 3, the location of the HMI can be upstream (HMI 134a) or downstream (HMI 134b) towards a direction of movement of a conveyor system. In each case, the HMI displays on its user interface, a preview of location of HMI installed on the palletizing machine, with respect to a direction of movement of a conveyor, i.e. a case conveyor.

As illustrated, in one aspect, a HMI 134a is located in an upstream direction 302 to a case conveyor. For example, the HMI 134a may be located on a machine, i.e. the palletizing unit 103, such that an interface of the HMI 134a is in an upstream direction 302 of movement of the conveyor. In this regard, one or more cases (such as the case number 2 or the case number 3) are placed on the case conveyor, i.e. a conveyor belt which moves in the upstream direction 302.

As illustrated, while the case number 2 or case number 3 moves in the infeed direction, a row pusher on the case conveyor pushes the cases, i.e. the case number 2 or the case number 3 depending on the row pusher direction for that case, towards the machine. In this regard, there may be multiple row pushers installed on the case conveyor, which push cases on different layers on conveyor belt of the case conveyor, depending on patterns created or selected by the HMI 134a. For instance, in an example, as illustrated, the row pusher may push the case number 3 on left end layer of the case conveyor moving towards the upstream direction 302. In another example, the row pusher may push the case number 2 on the right end layer on the case conveyor moving towards the upstream direction 302.

As illustrated, in another aspect, the HMI 134b may be located on the machine or the palletizing unit 103, in a direction downstream 304 towards the case conveyor. Accordingly, one or more row pushers on the case conveyor push the cases toward the machine. For example, in some embodiments, the one or more row pushers may push cases, e.g. case number 1 on right end layer on the conveyor belt, in the downstream direction 304. In some embodiments, the row pushers may push cases, e.g. case number 4 on the left end layer on the conveyor belt, in the downstream direction 304.

FIG. 4 illustrates a schematic representation of a user interface presenting HMI locations on the left or right of conveyors, according to one or more embodiments. Illustratively, in an embodiment, the HMI may be located on the machine or the palletizing unit 103, at a location towards left 402 (HMI 134c) or right 404 (HMI 134d), of the case conveyor. In this regard, in an embodiment, when the HMI 134c is located towards left 402, then graphics display on the HMI 134c would be for case number 5 or case number 8. In another embodiment, when the HMI 134d is located towards right 404 of the case conveyor and the palletizing unit 103, the HMI 134d will display case number 6 or case number 7. Accordingly, as illustrated in FIGS. 3 and 4, a graphical interface of the HMI displays (a) location of the HMI relative to the palletizing unit 103, case conveyor and direction of movement of the case conveyor, and (b) placement of the cases on layers on the case conveyor and direction of push from row pushers on the case conveyors, based on patterns created on the HMI 134a, 134b, 134c, or 134d.

### Example Data Conversion in Accordance with Embodiments of the Present Invention

In accordance with various embodiments, the present invention converts various data formats, including hexadecimal type data format and UDT type data format, to a uniformed data format, such as a pattern case view format described hereinafter, therefore enables the uniformity in generating previews of case placement patterns.

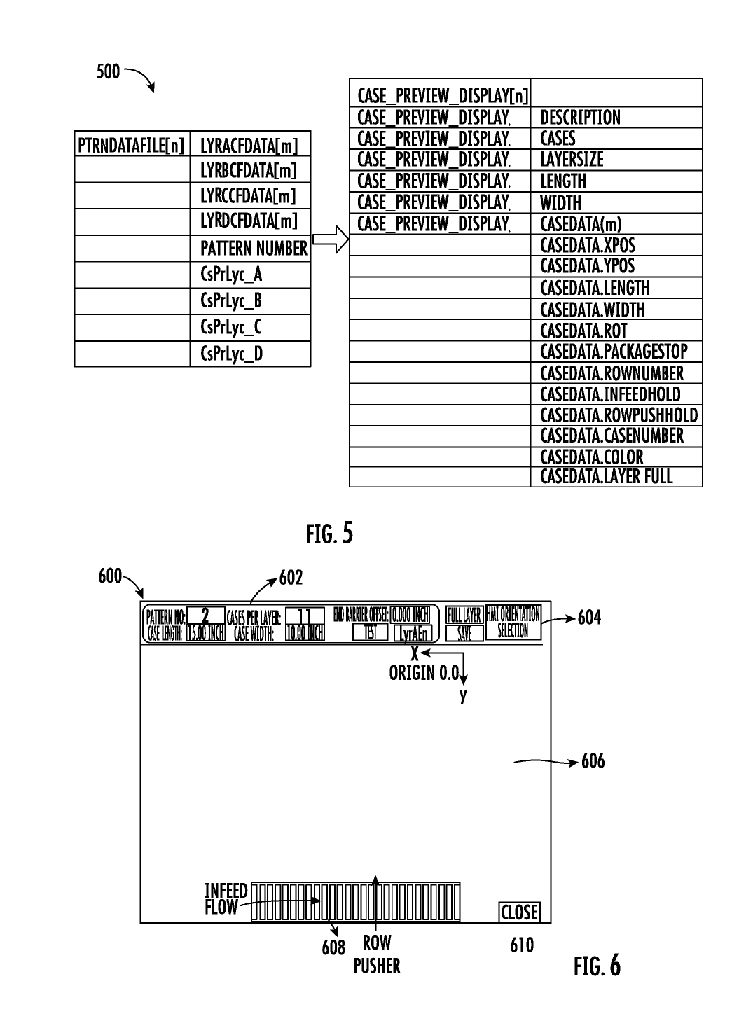

Patterns for case placements are created by processing pattern case data. The pattern case data is usually in a hexadecimal format or a user datagram protocol (UDP) supported data transfer protocol type (UDT) format. In various embodiments of the present invention, one or more processors, such as the processor subsystem 108, convert the pattern case data in a variety of formats to a pattern case view format. The case view format, in this regard, corresponds to a format which the processor subsystem 108 interprets for rendering data on the HMI 134. Illustratively, the pattern case data may comprise of various attributes related to cases, for instance, description of cases, size or dimensions including length, width, and height of cases, size or dimensions of layers on the pattern, number of layers on the pattern, number of cases per layer to be placed etc. In this regard, all of such attributes may be considered while creating the pattern via the HMI 134. For example, FIG. 5 illustrates converting an example pattern case data in hexadecimal format to the pattern case view format. The “PtrnDataFile” is an array of the pattern data, which contains Layer A, layer B, Layer C, and Layer D data on case-by-case basis in hexadecimal format. The “Case_Preview_Display” is an array of the converted case data.

### Example User Interfaces for Implementing Embodiments of the Present Invention

As described above, various embodiments of the present invention overcome technical challenges faced by conventional systems. For example, in conventional systems, Pattern Forming Screens use fixed graphics for each pattern that is programmed in the machine. If a new pattern is added, a new fixed graphic screen will need to be created. In various embodiments of the present invention, custom pattern preview (Pattern Forming Screens) dynamically creates a graphical representation of a case pattern by using the same pattern data that the palletizer uses. The new Pattern Forming Screens enable users to have a single HMI screen for visualization of pattern as well as creation of new pattern.

FIG. 6 illustrates a schematic view of an interface of the HMI 134, according to one or more embodiments. The HMI 134 may be utilized by an operator for various purposes. For instance, in some embodiments, the HMI 134 is utilized by the operator for creating and visualizing patterns, according to which various cases, such as boxes or cartons, are conveyed and machined by a palletizer and placed on a pallet. In this regard, the HMI 134 is adapted to display previews of newly created or existing pre-loaded patterns on its interface 600. Additionally, the HMI 134 is adapted to render dynamic changes on the previewed pattern in real-time, i.e. while a palletizer machine is in operation for placing cases on the pallet. Based on displaying on the interface 600, (a) the pattern previews and (b) the dynamic changes on the pattern previews, the operator may also utilize the HMI 134 for debugging and troubleshooting purposes. In this regard, the operator may refer to visualization provided on the interface 600 and resolve any issue, such as lag or a glitch, which may happen along a conveyor system, as the cases passes through a conveyor belt. Moreover, the operator may visualize both movement of cases on the infeed flow 608 of a conveyor and placement of cases on pallets based on the patterns and accordingly resolve or troubleshoot such any faulty issues, in real time, during operations of the conveyor system. As described above with regards to FIGS. 3-4, the installation location of the HMI determines the orientation of the interface of the HMI. In this regard, for example, the interface 600 illustrates an example orientation for Case 7 where the HMI is installed at the right side location.

As illustrated, on the interface 600 of the HMI 134, a pattern case data widget 602 provides input control accordance to an operator accessing the HMI 134, to input and display various parameters such as ones associated with patterns and cases. In this regard, the pattern case data widget 602 comprises of multiple fields illustrated as, pattern number, cases per layer, case length, case width, and an end barrier offset etc. In an example implementation of said embodiment, the operator may provide the inputs on different fields of the pattern case data widget 602. For instance, the HMI 134 may be adapted to receive inputs for creating a new case placement pattern for placement of various cases on pallets. In this regard, the inputs may correspond to drawing one or more case position placeholders, like rectangular or square shaped boxes, forming a pattern indicative of positions for placement of one or more cases by the palletizing unit 103 on the pallet. Illustratively, the inputs may be received from various input control mechanisms, such as the discrete I/O field device 146, analog I/O field device 148, or special I/O field devices 150, including but not limited to, a touch screen graphical display, keypad, microphone, speaker, haptic device, camera, gauges, light indicators, dials, switches, from the remote I/O communication module 138. In this regard, while receiving the inputs the HMI 134 may be adapted to also display the received inputs such as, number of cases per layer, width of each case, length of each case, on the interface 600 of the HMI 134.

Alternatively, in another embodiment, the HMI 134 may be adapted to receive inputs for selecting of a pre-loaded pattern, like one pre-defined pattern amongst several pattern forming HMIs 128, accessible to the processor subsystem 108, via the system memory 126. In this regard, based on the selected pre-loaded pattern, various pre-defined parameters including pattern number, cases per layer, case length, case width etc. may be displayed on the HMI 134, as soon as the operator selects the pre-loaded pattern.

As illustrated, a HMI orientation selection button 604 is provided on the interface 600 of the HMI 134. In this regard, the HMI orientation selection button 604 is adapted to facilitate a selection of an orientation of the HMI 134, with respect to a case conveyor. In this regard, an operator may perform a selection, i.e. by clicking on the HMI orientation selection button 604 to select an orientation of the HMI 134, for instance, any of upstream, downstream, left or right orientations as described in FIG. 3. As illustrated, the interface 600 of the HMI 134 includes a pattern previewing area 606 on which previews of various patterns, either newly created or selected by the operator may be displayed. The interface 600 of the HMI 134 may also be adapted to provide a visualization of the direction of infeed flow 608, i.e. a direction of movement of cases on an infeed conveyor, and a direction of row pusher, i.e. a direction in which various cases may be pushed on different layers along the conveyor. The direction of infeed flow 608 assists an operator in visualizing a direction of movement of a conveyor, in real-world and the movement of cases on the conveyor feed. The display of HMI orientation and the direction of infeed flow 608 on the interface 600, helps the operator in multiple aspects, including but not limited to, in creation of new patterns, selection of pre-loaded patterns, and/or any troubleshooting or debugging operation the operator may desire to perform while the palletizer is in execution. Further, the interface 600 renders a close button 610 for closing or turning off display of the HMI 134. Accordingly, in this regard, post creation or selection of the patterns, the operator may click on the close button 610, thereby turning of the display on the HMI 134.

FIG. 7 illustrates an interface 700 of the HMI 134 displaying previews of patterns. According to various example embodiments described herein, the HMI 134 is adapted to display previews of multiple patterns created or selected by an operator. As illustrated, previews of two patterns, pattern preview 702 and pattern preview 704, are displayed on the pattern previewing area 606. As described previously, there may be multiple layers for a conveyor based on which cases are to be placed on the pallet. Illustratively, different layers may accommodate different number of cases depending on case dimensions. In this regard, the previews of pattern (i.e. the pattern preview 702 and the pattern preview 704) correspond to two different patterns, each one represent a respective layer on the conveyor. For instance, in an embodiment, the pattern preview 702 may correspond to a first layer, i.e. Layer A and the pattern preview 704 may correspond to a second layer, i.e. Layer B, where the layer A includes 12 cases and the layer B includes 8 cases. In an embodiment, an operator, via the interface 700 of the HMI 134 may define number of cases per layer on conveyor belt to be 20. Accordingly, as illustrated, the pattern case data widget 602 displays count of cases per layer as 20. However, in other embodiments, number of cases per layer on the conveyor may change depending on various factors such as, but not limited to, dimensions of cases, type of product in cases etc. In accordance with some embodiments described herein, the processor subsystem 108 of the material handling system may self-optimize the patterns to provide automated adjustment for accommodating plurality of cases on the case placement zone, upon change in dimensions of the at least one selected case.

Illustratively, the patterns are created depending on a number of pattern forming factors such as dimensions of cases, number of cases to be placed on a layer, etc. As illustrated, in an example, the case length may be 15.00 inch and the case width may be 10.00 inch. Accordingly, the pattern previews 702 and 704 are displayed on the pattern previewing area 606 of the HMI 134, indicating that the case length is 15.00 inch and the case width is 10.00 inch. As illustrated, cases previewed for the pattern preview 704 are of dimensions different from cases previewed for the pattern of layer 706.

In accordance with one or more illustrated embodiments, the processor subsystem 108 may access the inputs received on the HMI 134 corresponding to the patterns for placement of items. In one aspect, the inputs on the HMI 134 may be received based on at least one of (a) drawing a pattern via an input control unit and/or (b) receiving pattern defining parameters and attributes corresponding to the pattern defining parameters such as ones displayed on the pattern case data widget 602. In this regard, the patterns may be created using rules defined based on the pattern defining parameters and associated attributes.

Further, as illustrated, the interface 700 of the HMI 134 also provides a visualization of a direction of infeed flow, i.e. a direction of movement of cases on a conveyor and a direction of row pusher, i.e. a direction in which various cases may be pushed on different layers along the conveyor. As described above with regards to FIGS. 3-4, the installation location of the HMI determines the orientation of the HMI. In this regard, for example, the interface 700 illustrates an example orientation for Case 1 where the HMI is installed at the downstream location.

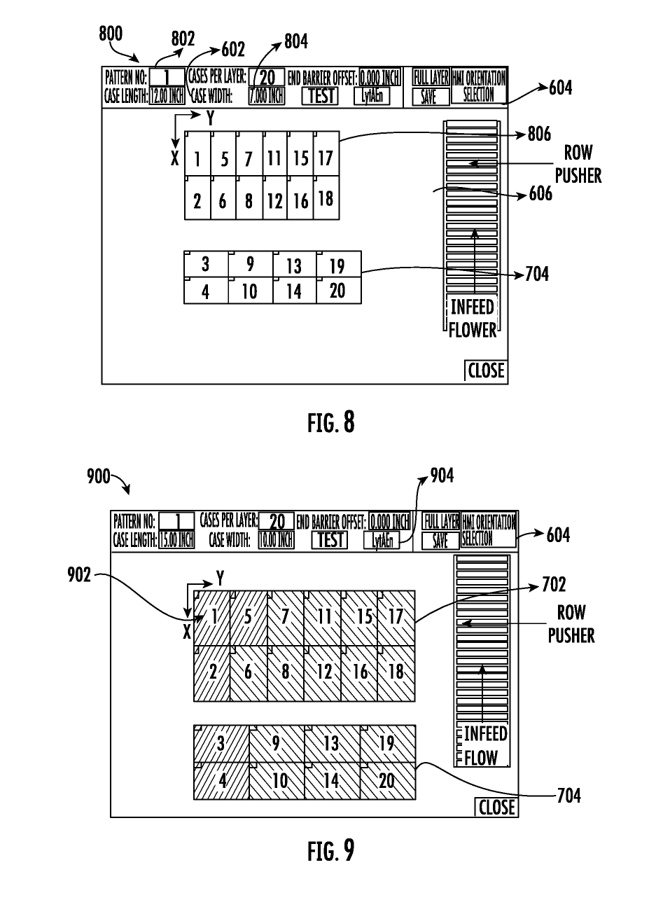

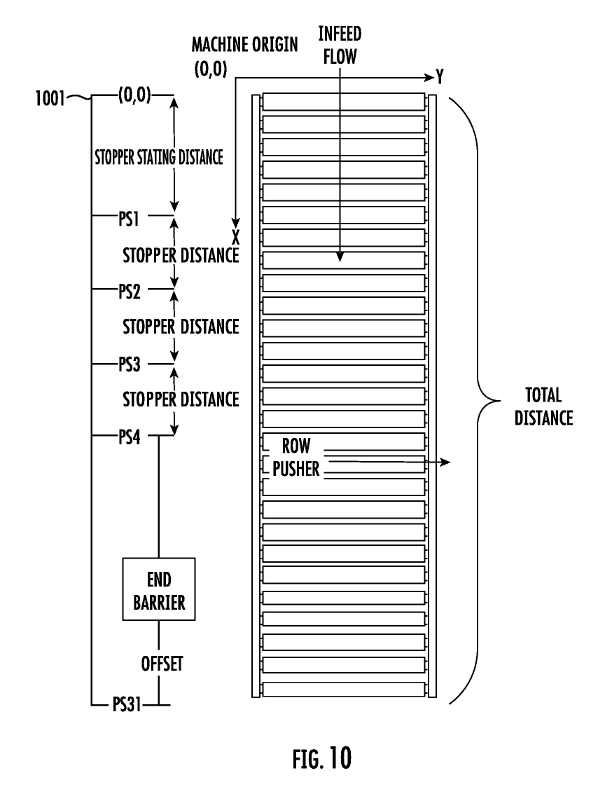

FIG. 8 illustrates an interface 800 of the HMI 134 displaying a preview of pattern after changing dimensions of cases, according to one or more embodiments. As illustrated, in the pattern case data widget 602, new dimensions of cases are displayed. For instance, compared to the interface 700 illustrated in FIG. 7, case length 802 is changed to 12.00 inches from 15.00 inches and case width 804 is changed to 7.00 inches from 10.00 inches. Illustratively, the changes in dimensions of the cases may occur based on, but not limited to, (a) a selection of a new pattern from amongst pre-loaded pattern forming HMIs 128 or (b) a creation of a new case placement pattern that includes defining new case dimensions, or (c) changing dimensions of cases for a previously stored pattern.

According to various embodiments disclosed herein, the interface 800 of the HMI 134 may be adapted to receive inputs for changing case dimensions in real-time, while the palletizing unit 103 is in execution. In that aspect, the interface 800 of the HMI 134 is to render a changed pattern preview 806, i.e. updated to pattern preview 806 from pattern preview 704 on the pattern previewing area 606. For rendering the changed pattern preview 806, in one aspect, the processor subsystem 108 may (a) access inputs received on the HMI, wherein the inputs corresponds to a change in at least one of pattern forming factors comprising: a pattern type, a pattern identifier, case dimensions, an offset distance, and number of cases to be placed per layer, and accordingly (b) change the pattern preview rendered on the HMI, in real time while the palletizing unit is in execution.

Thus, by way of operation, the interface 800 of the HMI 134 facilitates in providing dynamic, real-time previews, to an operator, while a palletizing machine, such as palletizing unit 103 is in execution for placing cases on pallet, depending on changes made to any parameter that was considered while creating the patterns, illustratively, dimensions of cases. A change in preview of the pattern visualized on the interface 800, assists the operator in realizing a change in real-world, which would occur upon placement of cases of different dimensions based on a pattern on the pallet. Accordingly, the operator may create or select a new pattern and view a preview of the pattern, based on the case dimensions for placement of the cases.

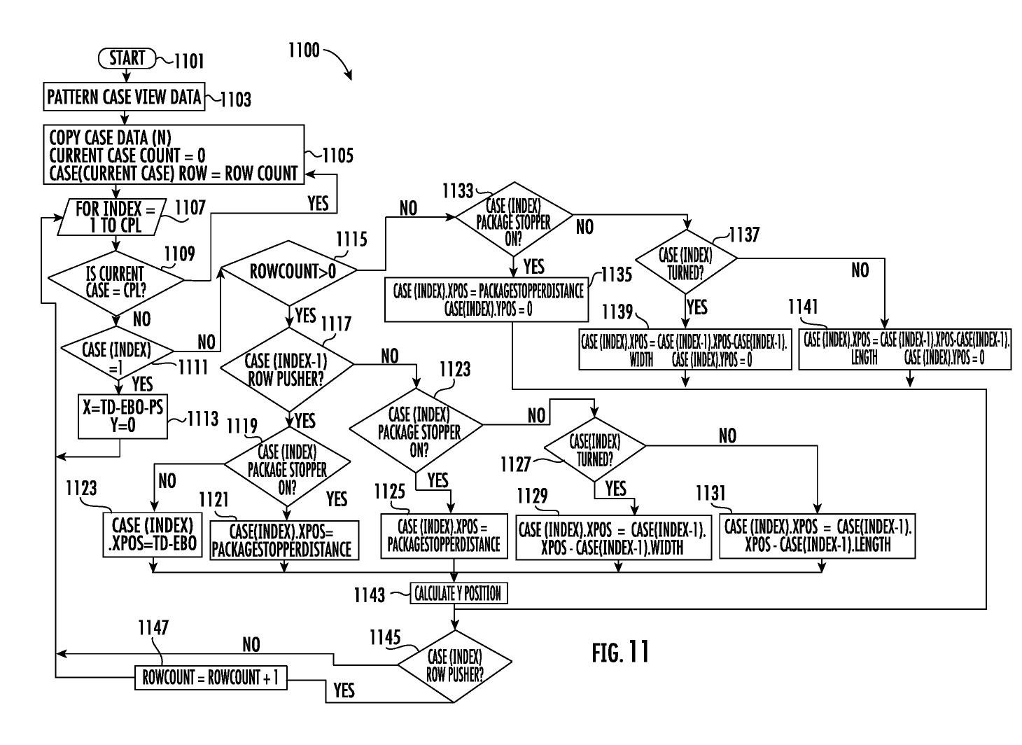

FIG. 9 illustrates an interface 900 of the HMI 134 to display dynamic changes 902, on a pattern previewed by the HMI 134, while a palletizer machine is in execution. The dynamic changes occurs in real-time, i.e. when the palletizing unit 103 is in execution to place cases on the pallet. According to various embodiments disclosed herein, the dynamic changes on the previewed pattern may occur based on detection of cases when positioned on a pallet. Illustratively, the detection of the pallets may be performed by any means including, but not limited to, an imaging device or a sensing unit such as, any of a light sensor, proximity sensor etc.

In some embodiments, the dynamic changes 902 may be in a form of a visual effect on the previewed pattern such as, change in color of one or more cases of the pattern previews 702 and 704. For instance, as illustrated, the interface 900 displays changes in color (illustrated as the background change) for cases number 1, 5, and 2 of the pattern preview 702 and for cases 3 and 4 for the pattern preview 704. Alternatively, the dynamic changes may be any other change indicated on the previewed pattern. For example, the dynamic changes may involve any of: highlighting an outline of a current case position on the pattern preview, change in size of current case position on the pattern preview, an extended glow on the current case position of the pattern preview, or any visual effect which may uniquely highlight the detected cases case positions on which cases are been placed on the pallet.

Accordingly, as multiple cases are placed on the pallet, in a manner as defined by the pattern preview 702 or 704, a color of the case on the respective pattern preview 702 or 704 changes. As illustrated, on the interface 800, the dynamic changes corresponds to change of a color of one or more case position placeholders, from amongst the multiple case position placeholders on which one or more cases respectively, are been placed on the pallet.

In an embodiment, the interface 800 is adapted to provide an operator an option to select a layer, i.e. a layer on the pallet for placing cases, using a layer selection button 904. In this regard, the interface 900 of the HMI 134 renders pattern previews corresponding to the selected layer. Accordingly, the HMI 134 facilitates in providing visualization for different patterns to be considered for different layers, depending on requirements of positioning cases on the pallets.

By way of implementation of various embodiments described herein, the HMI 134 provides assistance to an operator in multi-fold ways. Firstly, HMI 134 provides visualization of conveyor feed and movement of cases on the conveyor. Visualization of the conveyor feed, assists the operator in performing any troubleshooting operations or repairing faults along a conveyor assembly as the cases moves on the conveyor. Secondly, there is no need for manually preparing and interpreting complex source code hexadecimal files for pattern creation. Further, there is no need for repeatedly configuring and initializing a PLC, such as controller 102, with the prepared source code files. Moreover, by way of implementation of the embodiments described herein, the controller 102 may operate, in real time, and instructs commands for a palletizer to place cases on pallet, depending on pattern created via the HMI 134. Embodiments of the present invention reduce overall turnaround time and maintenance need for a palletizer and conveyer system. Additionally, the HMI 134 provisions an operator for changing and updating patterns along with changing requirements such as, but not limited to, case dimensions, number of cases to be placed on a layer etc. and also preview such changes on the HMI 134, which enables effective handling and positioning of cases on pallets with minimal resource consumption.

### Example Data Flows in Accordance with Embodiments of the Present Invention

Various embodiments of the present invention overcome technical drawbacks in the convention systems by utilizing innovative methods, including calculating case physical and graphic positions based on pattern case view data, the details of which are described hereinafter.

### Calculating the X Position of a Case

FIG. 10 is an example schematic diagram illustrating various calculations regarding the X position of a case in accordance with various embodiments of the present invention. In this regard, the origin for the physical position calculation is the machine origin, which, in some embodiments, is at the starting point of the notch for pusher bar track, as illustrated in FIG. 10.

In FIG. 10, case stopper setup 1001 shows example locations for case stoppers on an infeed flow. In some embodiments, the case stopper numbering begins at the machine origin and counts up toward the end barrier. The numbering for case stoppers is the same regardless of the number of case stoppers. For example, if a machine has two case stoppers, where the first case stopper is nearest to the machine origin and the second case stopper is in fourth position, then the first case stopper will be number one and the second case stopper will be number four. In another example, if a machine has only one case stopper at the fourth position, then its number will be four.

In various embodiments of the present invention, the case stoppers are at constant distance from each other, and the stopper starting distance is a fixed value. In some embodiments, the stopper distance is 2.125″, and the stopper starting distance is 11.75″. In some embodiments, if a package stop is activated for a case, then the package can be calculated based on the following formula:

PSO=SSD+(SD×PSN)

where PSO is the package stop offset, which indicates the stopping position of the case, SSD is the stopper starting distance, SD is the stopper distance, and PSN is the number of the case stopper.

FIG. 11 is an example data flow diagram illustrating method 1100 for calculating the X position of a case from the machine origin as shown in FIG. 10. As shown in FIG. 11, the X position of the case is calculated based on whether the case is turned (i.e. whether the case is rotated by the palletizing unit 103 as described above with regard to FIG. 1), whether any case stopper is activated, and whether the row pushers are used.

The method 1100 starts at block 1101. At block 1103, the method 1100 receives the pattern case view data as an input. As described above with reference to FIG. 5, various embodiments of the present invention convert data from a variety of formats into the pattern case view format.

At block 1105, the method 1100 copies each case data in a case layer from the pattern case view data, sets a case count as zero, and sets the initial row count. As described above, rows of cases are formed as cases are pushed from the infeed conveyor, and the row count (m) is a numerical value indicating the number of rows.

As indicated in block 1107, the method 1100 initially sets the index value as 1, and increases (in an increment of one) the index value each time block 1107 is performed, until the index value reaches the number of cases per layer. In this regard, the index value (n) is used to specify a particular case number. For example, if a case layer has eight cases, then the method 1100 initially sets the index value as 1, and increments the index value by one each time the method 1100 returns to block 1107, until the index value is 8.

At block 1109, the method 1100 determines whether the current case number has reached the cases per layer number (i.e. whether X-Y positions of all cases in a layer have been determined). If yes, then the method 1100 returns to block 1105, and continues the determination of X-Y positions of cases in another case layer. If no, then the method 1100 continues to block 1111.

At block 1111, the method 1100 determines whether the case value of current case equal to 1. If yes, then the method 1100 continues to block 1113, which sets the x value based on the following formula:

X=TD−EBO−PS

where TD is the total distance, EBO is the end barrier offset, and PS is the package stopper distance, as illustrated, for example, in FIG. 10. Block 1113 also sets the Y value as zero. The method 1100 then returns to block 1107, and increases the index value by one. In this instance, Case[Index]=1 indicates case numbering starts from 1.

If, at block 1111, the method 1100 determines that the case value of the current case does not equal to 1, then the method 1100 continues to block 1115, where the method 1100 determines whether the row count is more than zero. If yes, then the method 1100 continues to block 1117, which determines whether any row pusher is activated in the previous case. For example, if the current case is case number 10, then block 1117 determines whether case number 9 has been pushed by one or more row pushers.

If, at block 1117, the method 1100 determines that the row pusher is activated for the previous case (i.e. the previous case has been pushed by the one or more row pushers), then the method continues to block 1119, which determines whether any case stopper is activated for the current case. If no, then the method 1100 proceeds to block 1123, in which the X position of the case is determined based on the following formula:

Case(Index)·XPos=TD−EBO

where Case(Index)·XPos is the X position of the current case (n), TD is the total distance, and EBO is the end barrier offset, as illustrated, for example, in FIG. 10. In other words, at block 1119, the method 1100 concludes that the current case has reached the end barrier.

If, at block 1119, the method 1100 determines that the case stopper is activated for the current case, then the method 1100 continues to block 1121, in which the X position of the case is determined based on the following formula:

Case(Index)·XPos=PackageStopperDistance

where Case(Index)·XPos is the X position of the current case (n), PackageStopperDistance is the distance of the activated case stopper from the machine origin, which is described, for example, with regard to FIG. 10. In other words, at block 1121, the method 1100 calculates the X position of the current case based on the case stopper distance.

If, at block 1117, the method 1100 determines that the row pusher is not activated for the previous case, then the method 1100 proceeds to block 1123, which determines whether any case stopper is activated for the current case. If yes, then the method 1100 proceeds to block 1125, in which the X position of the case is determined based on the following formula:

Case(Index)·XPos=PackageStopperDistance

where Case(Index)·XPos is the X position of the current case (n), PackageStopperDistance is the distance of the activated case stopper from the machine origin, which is described, for example, with regard to FIG. 10. In other words, at block 1125, the method 1100 calculates the X position of the current case based on the case stopper distance.

If, at block 1123, the method 1100 determines that no case stopper is activated for the current case, then the method 1100 continues to block 1127, which determines whether the current case is turned. In other words, block 1127 determines whether the current case is rotated by, for example, one of the case turners described above with regard to FIG. 1, so that the shorter side of the case (the width side) parallels the X axis.

If the current case is turned, then the method 1100 continues to 1129, in which the X position of the case is determined based on the following formula:

Case(Index)·XPos=Case(Index-1)·XPos−Case(Index-1)·Width

where Case(Index)·XPos is the X position of the current case (n), Case(Index-1)·XPos is the X position of the previous case (n−1), and Case(Index-1)·Width is the width of the previous case (n−1).

If, at block 1127, the method 1100 determines that the current case is not turned, then the method 1100 continues to block 1131, in which the X position of the case is determined based on the following formula:

Case(Index)·XPos=Case(Index-1)·XPos−Case(Index−1)·Length

where Case(Index)·XPos is the X position of the current case (n), Case(Index-1)·XPos is the X position of the previous case (n−1), and Case(Index-1)·Length is the length of the previous case (n−1).

Referring back to block 1115, the method 1100 determines that the row count is not more than zero, then the method 1100 proceeds to block 1133, which determines whether any case stopper is activated for the current case. If yes, then the method 1100 proceeds to block 1135, in which the X position of the case is determined based on the following formula:

Case(Index)·XPos=PackageStopperDistance

where Case(Index)·XPos is the X position of the current case (n), PackageStopperDistance is the distance of the activated case stopper from the machine origin, which is described, for example, with regard to FIG. 10. In other words, at block 1135, the method 1100 calculates the X position of the current case based on the case stopper distance.

If, at block 1133, the method 1100 determines that no case stopper is activated for the current case, the method 1100 proceeds to block 1137, which determines whether the current case has been turned. If yes, then the method 1100 proceeds to block 1139, in which the X position of the case is determined based on the following formula:

Case(Index)·XPos=Case(Index-1)·XPos−Case(Index-1)·Width

where Case(Index)·XPos is the X position of the current case (n), Case(Index-1)·XPos is the X position of the previous case (n−1), and Case(Index-1)·Width is the width of the previous case (n−1).

If, at block 1137, the method 1100 determines that the current case is not turned, then the method 1100 proceeds to block 1141, in which the X position of the case is determined based on the following formula:

Case(Index)·XPos=Case(Index-1)·XPos−Case(Index-1)·Length

where Case(Index)·XPos is the X position of the current case (n), Case(Index-1)·XPos is the X position of the previous case (n−1), and Case(Index-1)·Length is the length of the previous case (n−1).

After the method 1100 determines the X position of the current case in one of blocks 1121, 1123, 1125, 1129, 1131, 1135, 1139, and 1141, the method 1100 continues to block 1143, in which the Y position of the current case is calculated, details of which are described hereinafter.

At block 1145, the method 1100 determines whether row pushers are activated for the current case. If yes, the method increments the row counter by one at block 1147, and returns to block 1107. If no, the method 1100 returns to block 1107 without incrementing the row count.

### Calculating the Y Position of a Case

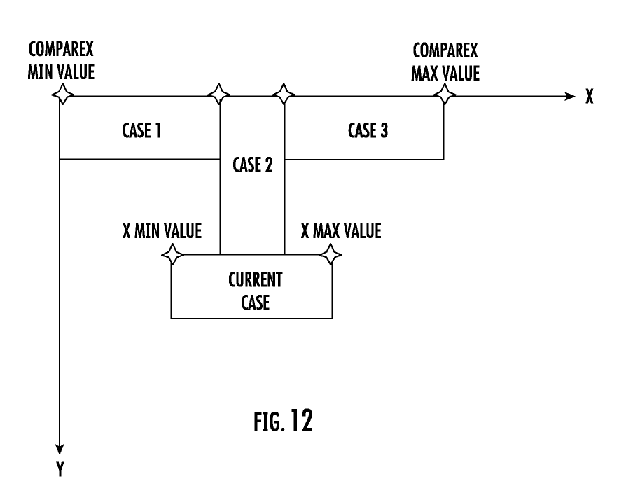

FIG. 12 is an example schematic diagram illustrating various calculations regarding the Y position of a case in accordance with various embodiments of the present invention. In this regard, the Y position is based on the machine origin as illustrated in FIG. 10. FIG. 11 is an example data flow diagram illustrating method 1300 for calculating the Y position of a case from the machine origin as shown in FIG. 10.

In various embodiments, the present invention determines whether the current case is in the first row. If yes, then the Y position of the current case is zero. In other words, the Y positions for all cases in the first row are set to be zero.

If the current case is not in the first row, various embodiments of the present invention then calculates the Y position of the current case based on the positions of other cases that have already been placed. In this regard, various embodiments of the present invention use a X Max value and a X Min value of the current case, together with a CompareX Max value and a CompareX Min value for all the cases that have been placed prior to the current case, to determine the Y position of the current case, as shown in FIG. 12.

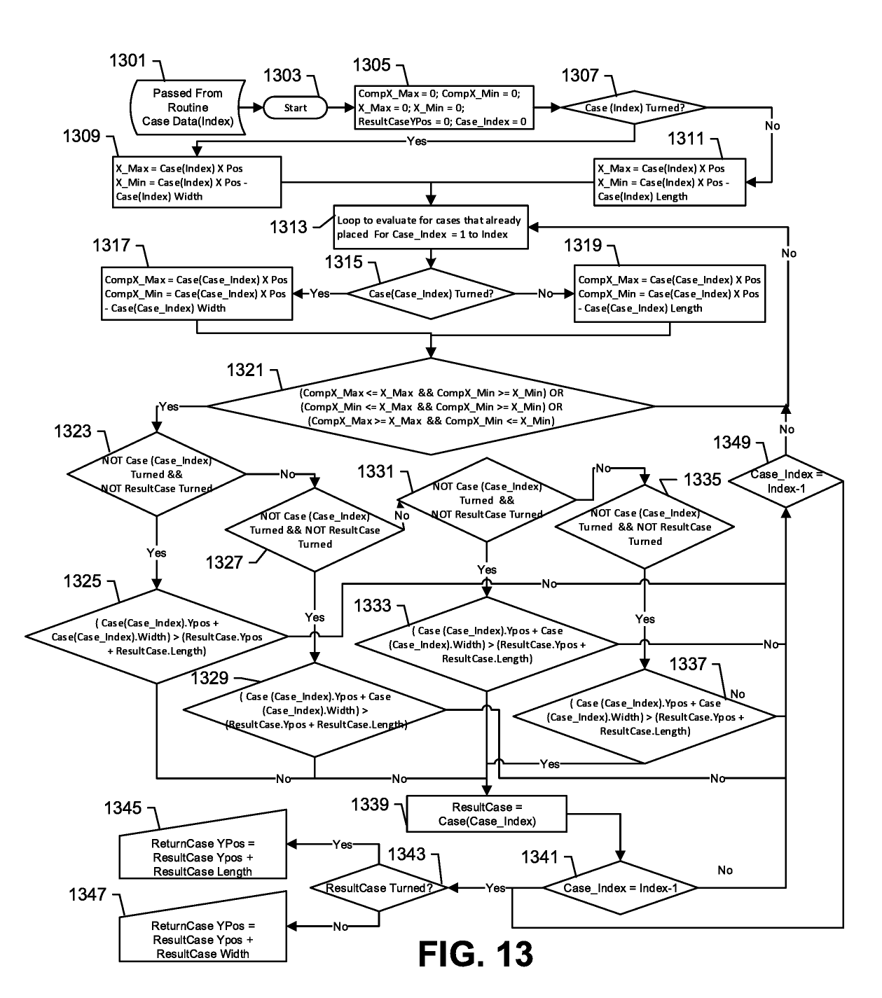

For example, as shown in FIG. 13, the process 1300 is initiated at block 1301 (which refers to block 1143 of FIG. 11) and starts at block 1303. At block 1305, the process 1300 sets the X Max value, the X Min value, the CompareX Max value, and the CompareX Min value to zero. The process 1300 also sets the case_index value to zero, and the Y position of the result case to zero, details of which are described hereinafter.

The X Max value and the X Min value are calculated based on whether the current case is turned, as shown in block 1307 of FIG. 13. If the current case is turned, then the X Max value and the X Min value are calculated based on the following formulas:

X_Max=Case(Index)·XPos

X_Min=Case(Index)·XPos−Case(Index)·Width

where X_Max is the X Max value of the current case, Case(Index)·XPos is the X position of the current case, X_Min is the X Min value of the current case, and Case(Index)·Width is the width of the current case. This is shown in block 1309 of FIG. 13.

If the current case is not turned, then the X Max value and the X Min value are calculated based on the following formulas:

X_Max=Case(Index)·XPos

X_Min=Case(Index)·XPos−Case(Index)·Length

where X_Max is the X Max value of the current case, Case(Index)·XPos is the X position of the current case, X_Min is the X Min value of the current case, and Case(Index)·Length is the length of the current case. This is shown in block 1311 of FIG. 13.

After calculating the X Max value and the X Min value for the current case, various embodiments of the present invention then calculate the CompareX Max value and the CompareX Min value for all the cases that have been placed prior to the current case, as shown in FIG. 12. In some embodiments, the CompareX Max value and the CompareX Min value are calculated by evaluating each case that has been placed based on whether it is turned. For example, as shown in block 1313, the process 1300 creates a loop to evaluate each case that are already placed, and determines whether each case has been turned at block 1315.

If the previously placed case is turned, then the CompareX Max value and the CompareX Min value are calculated based on the following formulas:

CompX_Max=Case(Case_Index)·XPos

CompX_Min=Case(Case_Index)·XPos−Case(Case_Index)·Width

where CompX_Max is the CompareX Max value of a previously placed case, Case(Case_Index)·XPos is the X position of the previously placed case, CompX_Min is the CompareX Min value of the previously placed case, and Case(Case_Index)·Width is the width of the previously placed case. This is shown in block 1317 of FIG. 13.

If the previously placed case is not turned, then the CompareX Max value and the CompareX Min value are calculated based on the following formulas:

CompX_Max=Case(Case_Index)·XPos

CompX_Min=Case(Case_Index)·XPos−Case(Case_Index)·Length

where CompX_Max is the CompareX Max value of a previously placed case, Case(Case_Index)·XPos is the X position of the previously placed case, CompX_Min is the CompareX Min value of the previously placed case, and Case(Case_Index)·Length is the length of the previously placed case. This is shown in block 1319 of FIG. 13.

The above-referenced calculations are carried out from the first case that has been placed to the last placed case prior to the current case, and, once the CompareX Max value and the CompareX Min value for a previously placed case are calculated, various embodiments of the present invention then compare the X Max value and the X Min value with the CompareX Max value and the CompareX Min value to get a “result case,” for example, Case 2 as shown in FIG. 12.

For example, at block 1321 of FIG. 13, the process 1300 determines whether the following condition is true for each case:

(CompX_Max<=X_Max && CompX_Min>=X_Min) OR (CompX_Min<=X_Max && CompX_Min>=X_Min) OR (CompX_Max>=X_Max && CompX_Min<=X_Min)

If, at block 1321, the process 1300 determines that the above condition is not true, then the process 1300 returns to block 1313 and continues the loop.

If, at block 1321, the process 1300 determines that the above condition is true, then the process 1300 proceeds to block 1323, which in turn identifies the result case through blocks 1323, 1325, 1327, 1329, 1331, 1333, 1335, and 1337, as applicable, until an initial result case is identified at block 1339. At block 1339, the process 1300 sets the initial result case equals to case(case_index).

The process 1300 then proceeds to block 1341, which determines whether the case_index value equals to index minus one. If yes, then initial result case is determined as the result case for calculating the Y position of the current case.

Once the result case is determined, the Y position of the current case is determined based on whether the result case is turned or not, as shown in block 1343 of FIG. 13. If the result case is turned, then:

Case(Index)·YPos=ResultCase·YPos+ResultCase·Length

where Case(Index)·YPos is the Y position of the current case, ResultCase·YPos is the Y position of the result case, and ResultCase·Length is the length of the result case, as shown in FIG. 12. This is shown in block 1345 of FIG. 13.

If the result case is not turn, then:

Case(Index)·YPos=ResultCase·YPos+ResultCase·Width

where Case(Index)·YPos is the Y position of the current case, ResultCase·YPos is the Y position of the result case, and ResultCase·Width is the width of the result case. This is shown in block 1347 of FIG. 13.

If, at block 1341, the process 1300 determines that the case_index value does not equal to index minus one, then the process 1300 proceeds back to block 1349, which in turn returns back to block 1313 based on the result of whether case_index value equals to index minus one.

After the Y position of the current case is determined, various embodiments of the present invention return to black 1143 described above with reference to FIG. 11.

### Calculating Graphic Location

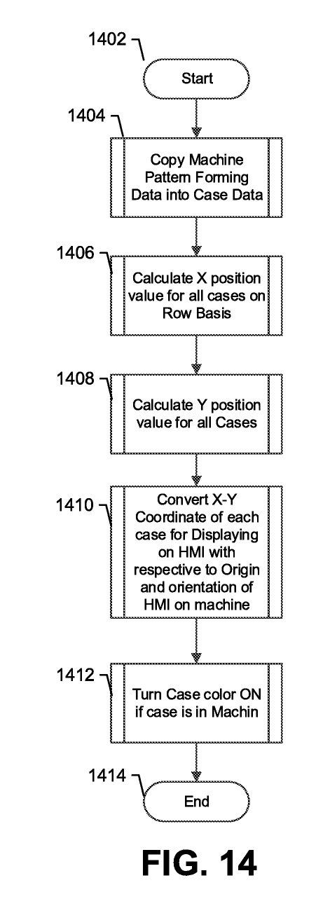

FIG. 14 illustrates a method 1400 of determining the graphic locations of a case on a HMI in accordance with various embodiments of the present invention.

The method 1400 starts at block 1402. At block 1404, the method 1400 copies machine pattern forming data into case data. In various embodiments, the process of block 1404 may be implemented in accordance with various methods described above with reference to at least FIGS. 5 and 11.

At block 1406, the method 1400 calculates X position values for all cases on a row basis. In various embodiments, the calculations of block 1406 may be conducted in accordance with various methods described above with reference to at least FIGS. 10-11.

At block 1408, the method 1400 calculates Y position values for all cases. In various embodiments, the calculations of block 1408 may be conducted in accordance with various methods described above with reference to at least FIGS. 12-13.

At block 1410, the method 1400 converts X-Y Coordinate of each case for displaying on HMI with respective to origin and orientation of HMI on machine. In various embodiments, the orientation of HMI may be determined in accordance with various methods described above with reference to at least FIGS. 3-4. The conversion of the X-Y coordinate for each case can be implemented based on applicable conversion methods.

At block 1412, the method 1400 dynamically changes the color of cases as they are placed in the machine in real-time. In various embodiments, the process of block 1412 may be conducted in accordance with various methods described above with reference to at least FIG. 9.

The process 1400 ends at block 1414.

### Additional Implementation Details

One or more of the embodiments of the disclosure described can be implemented, at least in part, using a software-controlled programmable processing device, such as a microprocessor, digital signal processor or other processing device, data processing apparatus or system. Thus, it is appreciated that a computer program for configuring a programmable device, apparatus or system to implement the foregoing described methods is envisaged as an aspect of the present disclosure. The computer program may be embodied as source code or undergo compilation for implementation on a processing device, apparatus, or system. Suitably, the computer program is stored on a carrier device in machine or device readable form, for example in solid-state memory, magnetic memory such as disk or tape, optically or magneto-optically readable memory such as compact disk or digital versatile disk, flash memory, etc. The processing device, apparatus or system utilizes the program or a part thereof to configure the processing device, apparatus, or system for operation.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

That which is claimed:

1. A palletizing system, comprising:
a palletizing unit, comprising at least one pallet; and
a controller in electronic communication with the palletizing unit, wherein the controller comprising a processor subsystem in electronic communication with a user interface device to execute a pattern forming human-machine interface (HMI), wherein the pattern forming HMI is configured to:
receive, via the user interface device, inputs corresponding to one of:
creation of a new case placement pattern; or
selection of a pre-defined case placement pattern from a set of pre-defined case placement patterns, wherein each of the new case placement pattern and the set of pre-defined case placement patterns is representative of a case placement by the palletizing unit; and
display on the user interface device, in real-time while the palletizing unit is in execution, a preview of one of the created new case placement pattern or the selected pre-defined case placement pattern based on the inputs received via the user interface device; and
provide dynamic visual indications on the preview, wherein the dynamic visual indications indicate case placements in real-time on a pallet of the at least one pallet by the palletizing unit.

2. The palletizing system of claim 1, wherein inputs corresponding to the creation of the new case placement pattern comprise at least one of: a pattern type, a pattern identifier, case dimensions, an offset distance, or a cases per layer number.

3. The palletizing system of claim 1, wherein displaying on the user interface device, in real-time while the palletizing unit is in execution, the preview is based on accessing plurality of pattern forming factors comprising at least one of: a pattern type, a pattern identifier, case dimensions, an offset distance, or a cases per layer number.

4. The palletizing system of claim 1, wherein the pattern forming HMI is further configured to:
receive, via the user interface device, inputs correspond to one or more changes in at least one of pattern forming factors comprising: a pattern type, a pattern identifier, case dimensions, an offset distance, or a cases per layer number; and
change the preview, in real-time while the palletizing unit is in execution, based on the received inputs.

5. The palletizing system of claim 1, wherein the pattern forming HMI is further configured to:
provide, on the user interface device, a selectable icon for selecting a HMI orientation with respect to the palletizing unit, wherein the HMI orientation is selected from: an up-left side relative to the palletizing unit, an up-right side relative to the palletizing unit, a down-right side relative to the palletizing unit, a down-left side relative to the palletizing unit, a left-up side relative to the palletizing unit, a left-down side relative to the palletizing unit, a right-up side relative to the palletizing unit, or a right-down side relative to the palletizing unit.

6. The palletizing system of claim 1, wherein the preview comprises a plurality of case position placeholders indicative of positions where cases are to be placed by the palletizing unit.

7. The palletizing system of claim 6, wherein the dynamic visual indications comprise dynamic color adjustments on one or more case position placeholders of the plurality of case position placeholders, wherein each of the dynamic color adjustments indicates a corresponding case being placed by the palletizing unit in real-time.

8. The palletizing system of claim 1, wherein the pattern forming HMI is further configured to:
display, on the user interface device, an infeed flow visualization indicative of a movement direction of infeed cases on an infeed conveyor, wherein the infeed cases are placed by the palletizing unit on the pallet.

9. The palletizing system of claim 1, wherein the pattern forming HMI is further configured to:
receive inputs to search the set of pre-defined case placement patterns stored in a non-transitory memory connected to the processor subsystem.

10. The palletizing system of claim 1, wherein displaying on the user interface device, in real-time while the palletizing unit is in execution, the preview further comprises:
generating, based on the inputs received via the user interface device, pattern case view data, wherein the pattern case view data is indicative of operation sequences to be performed by the palletizing unit; and
determining, for each case on the pallet, a case position based on the pattern case view data.

11. A method comprising:
receiving, via a user interface of a pattern forming human-machine interface (HMI), inputs corresponding to one of: (a) creation of a new case placement pattern, or (b) selection of a pre-defined case placement pattern from a set of pre-defined case placement patterns, wherein each of the new case placement pattern and the set of pre-defined case placement patterns is representative of a case placement by the palletizing unit, and
displaying, in real-time while the palletizing unit is in execution, on the user interface, a preview of one of the created new case placement pattern or the selected pre-defined case placement pattern based on the inputs received via the user interface; and
providing dynamic visual indications on the preview, wherein the dynamic visual indications indicate case placements in real-time on a pallet by a palletizing unit.

12. The method of claim 11, wherein inputs corresponding to the creation of the new case placement pattern comprise at least one of: a pattern type, a pattern identifier, case dimensions, an offset distance, or a cases per layer number.

13. The method of claim 11, wherein displaying on the user interface, in real-time while the palletizing unit is in execution, the preview is based on accessing plurality of pattern forming factors comprising at least one of: a pattern type, a pattern identifier, case dimensions, an offset distance, or a cases per layer number.

14. The method of claim 11, further comprising:
receiving, via the user interface, inputs correspond to one or more changes in at least one of pattern forming factors comprising: a pattern type, a pattern identifier, case dimensions, an offset distance, or a cases per layer number; and
changing the preview, in real-time while the palletizing unit is in execution, based on the received inputs.

15. The method of claim 11, further comprising:
providing, on the user interface, a selectable icon for selecting a HMI orientation with respect to the palletizing unit, wherein the HMI orientation is selected from: an up-left side relative to the palletizing unit, an up-right side relative to the palletizing unit, a down-right side relative to the palletizing unit, a down-left side relative to the palletizing unit, a left-up side relative to the palletizing unit, a left-down side relative to the palletizing unit, a right-up side relative to the palletizing unit, or a right-down side relative to the palletizing unit.

16. The method of claim 11, wherein the preview comprises a plurality of case position placeholders indicative of positions where cases are to be placed by the palletizing unit.

17. The method of claim 16, wherein the dynamic visual indications comprise dynamic color adjustments on one or more case position placeholders of the plurality of case position placeholders, wherein each of the dynamic color adjustments indicates a corresponding case being placed by the palletizing unit in real-time.

18. The method of claim 11, further comprising:
displaying, on the user interface, an infeed flow visualization indicative of a movement direction of infeed cases on an infeed conveyor, wherein the infeed cases are placed by the palletizing unit on the pallet.

19. The method of claim 11, further comprising:
searching, via the user interface, the set of pre-defined case placement patterns based on one or more pattern forming inputs provided via the user interface.

20. The method of claim 11, further comprising:
generating, based on the inputs received via the user interface, pattern case view data, wherein the pattern case view data is indicative of operation sequences to be performed by the palletizing unit; and
determining, for each case on the pallet, a case position based on the pattern case view data.
